(19) United States
(12) Patent Application Publication
(10) Pub. No.: US 2022/0278306 A1
(43) Pub. Date: Sep. 1, 2022

(54) METHOD OF PRODUCING ELECTRODE FOR SECONDARY BATTERY AND ELECTRODE

(71) Applicant: Prime Planet Energy & Solutions, Inc., Tokyo (JP)

(72) Inventors: Naohiro MASHIMO, Toyota-shi (JP); Katsushi ENOKIHARA, Toyota-shi (JP); Haruka SHIONOYA, Toyota-shi (JP)

(21) Appl. No.: 17/680,305

(22) Filed: Feb. 25, 2022

(30) Foreign Application Priority Data
Mar. 1, 2021 (JP) 2021-031946

(51) Int. Cl. H01M 4/04; H01M 4/38

(52) U.S. Cl. CPC H01M 4/0435; H01M 4/0404; H01M 4/386; H01M 4/387; H01M 2004/025

(57) ABSTRACT

A method of producing an electrode disclosed here includes a step in which a moisture powder formed of agglomerated particles; a step in which a coating film composed of the moisture powder is formed using the moisture powder on the electrode current collector when a gas phase of the coating film remains; a step in which a concave/convex shape is formed on a surface part of the coating film; a step in which a coating material containing at least one type of inorganic compound is applied to the coating film on which the concave/convex shape is formed; and a step in which the coating film and the coating material are dried, and the electrode having an electrode active material layer and a coating component in a concave part of the concave/convex shape on the electrode active material layer is formed.

### CROSS REFERENCE TO RELATED APPLICATIONS

Priority is claimed on Japanese Patent Application No. 2021-031946, filed Mar. 1, 2021, the content of which is incorporated herein by reference.

### BACKGROUND OF THE DISCLOSURE

### 1. Technical Field

The present disclosure relates to a method of producing an electrode for a secondary battery and the electrode.

### 2. Description of Background

Secondary batteries such as lithium ion secondary batteries are lighter in weight and have a higher energy density than conventional batteries, and thus are preferably used as high-output power supplies for mounting on vehicles or power supplies for computers and mobile terminals. As a typical structure of a positive electrode and a negative electrode (hereinafter simply referred to as an “electrode” when positive and negative electrodes are not particularly distinguished) included in this type of secondary battery, one in which an electrode active material layer containing an electrode active material as a main component is formed on one surface or both surfaces of a foil-like electrode current collector may be exemplified.

Such an electrode active material layer is formed by applying a slurry (paste) electrode material prepared by dispersing solid components such as an electrode active material, a binding material (binder), and a conductive material in a predetermined solvent to a surface of a current collector to form a coating film, drying the coating film, and then applying a pressing pressure to obtain a predetermined density and thickness. Alternatively, in place of forming a film using such a mixture slurry, moisture powder sheeting (MPS) in which a film is formed using a so-called moisture powder in which a granular aggregate is formed in a state in which the proportion of solid components is relatively higher than that of the mixture slurry, and the solvent is held on the surface of active material particles and the surface of binder molecules is being examined. For example, Japanese Patent Application Publication No. 2019-057383 and Japanese Patent Application Publication No. 2020-136016 disclose methods of producing an electrode for a lithium ion secondary battery, including forming an active material layer using a moisture powder.

In addition, application of a coating solution to the electrode active material layer is being examined. For example, Japanese Patent Application Publication No. 2019-057431 discloses a method of forming an insulation layer by applying a coating solution containing insulating particles to the surface of a negative electrode active material layer obtained by moisture powder sheeting.

### SUMMARY

According to the results of examination performed by the inventors, it has been found that the effect of the coating component is insufficient when a coating solution is simply applied to the surface of the active material layer. That is, the surface area of the active material layer that can come into contact with a coating component is small, and the effect of the coating component is not sufficiently exhibited in the thickness direction (in particular, on the side of a current collector) of the active material layer. Therefore, there is a need for a technology for increasing the area in which the active material layer and the coating component come into contact with each other and exhibiting the effect of the coating component also in the thickness direction of the active material layer.

The present disclosure has been made in view of such circumstances, and a main object of the present disclosure is to provide a method of producing an electrode including forming a desired concave/convex shape on a coating film and realizing an increase in a surface area of an active material layer and disposition of a coating component in a thickness direction. In addition, another object is to provide an electrode having such characteristics.

In order to realize the above object, the inventors examined the content of MPS and properties of the moisture powder that has been used for MPS. They found that, although a conventional moisture powder has a higher solid component proportion than a slurry (paste) electrode material, an existence form of solid components of agglomerated particles constituting a moisture powder and a solvent is close to a capillary state to be described below. That is, they focused on the fact that a relatively large amount of a solvent is tightly constrained inside agglomerated particles constituting a moisture powder and a solvent layer is formed on the surface of the agglomerated particles. In addition, they focused on the fact that the existence form of the gas phase (void) present in the agglomerated particles has not been examined.

Accordingly, they found that, unlike the conventional moisture powder, existence forms of a solid component (solid phase), a solvent (liquid phase) and voids (gas phase) are brought into a pendular state or funicular state to be described below (in particular, the funicular I state), in other words, there is provided an appropriate amount of a solvent (liquid phase) that is sufficient for crosslinking between electrode active material particles forming agglomerated particles constituting a moisture powder, voids that communicate with the outside are formed in the agglomerated particles, a solvent layer is not substantially formed on the surface of the agglomerated particles, and thus a desired concave/convex shape can be imparted to a coating film before drying formed on a current collector. They found that, when a coating solution (for example, a coating material containing an inorganic compound) is applied to a coating film having such a concave/convex shape, it is possible to increase a surface area in which a coating component made of a coating material and an electrode active material layer made of a coating film come into contact with each other, and dispose a coating component in the thickness direction of the electrode, and thus completed the present disclosure.

That is, a method of producing an electrode disclosed here is a method of producing an electrode having any electrode current collector of positive and negative electrodes and an electrode active material layer, the method including the following steps: a step in which a moisture powder is prepared, the moisture powder is formed of agglomerated particles containing at least an electrode active material, a binder resin, and a solvent, and at least 50% by number or more of the agglomerated particles have the following properties: (1) a solid phase, a liquid phase, and a gas phase form a pendular state or a funicular state; and (2) a layer of the solvent is not observed on the surface of the agglomerated particles in electron microscope observation; a step in which a coating film composed of the moisture powder is formed using the moisture powder on the electrode current collector while leaving a gas phase of the coating film; a step in which a concave/convex shape is formed on a surface part of the coating film with a predetermined pattern and a certain pitch; a step in which a coating material containing at least one type of inorganic compound is applied to the coating film on which the concave/convex shape is formed; and a step in which the coating film formed on the current collector and the coating material are dried, and the electrode having an electrode active material layer made of the coating film and a coating component made of the coating material disposed in a concave part of the concave/convex shape on the active material layer is formed.

According to the production method, it is possible to impart a desired concave/convex shape to the formed coating film, and apply a coating material containing at least one type of inorganic compound to an electrode having such a concave/convex shape before drying. As described above, if a film is formed using the moisture powder in which a solid phase, a liquid phase, and a gas phase are in a pendular state or a funicular state (in particular, the funicular I state) when the gas phase remains, it is possible to produce an electrode having a predetermined concave/convex shape. The coating film having a concave/convex shape can have an increased surface area and have a space (concave part) in which the coating component can be disposed in the thickness direction of the electrode. Accordingly, it is possible to suitably produce an electrode that realizes an increase in the surface area of the active material layer and disposition of the coating component in the thickness direction.

In one preferable aspect of the method of producing an electrode disclosed here, the concave/convex forming step is carried out such a way as to form a concave/convex surface in which, when the surface area of a reference area of the coating film indicated by L cm×B cm (L and B are integers of 3 or higher) is measured at n (n is an integer of 5 or higher) different points, the average surface area is 1.05×L×B cm2 or more.

With such a configuration, it is possible to increase the surface area in which the coating film and the coating component come into contact with each other, and the effect obtained by applying the coating component is further exhibited.

In one preferable aspect of the method of producing an electrode disclosed here, the inorganic compound contains at least one selected from the group consisting of alumina, boehmite, silica, magnesia, zirconia and titania.

With such a configuration, it is possible to improve the mechanical strength of the electrode, and it is possible to produce an electrode that can maintain a concave/convex shape even if the electrode expands and contracts during charging/discharging.

In one preferable aspect of the method of producing an electrode disclosed here, the coating material may contain at least one type of active material as the inorganic compound, and the active material may contain at least one metal element of silicon and tin as a constituent element.

With such a configuration, when the active material which contributes to increasing the capacity of the secondary battery but the change in volume due to charging/discharging is large and tends to cause cracks is disposed in the concave part, it is possible to produce an electrode having an increased capacity while alleviating such cracks.

In order to achieve another object, an electrode for a secondary battery is provided. An electrode for a secondary battery disclosed here is any electrode of positive and negative electrodes of a secondary battery, including an electrode current collector, an electrode active material layer formed on the electrode current collector, and a coating component containing at least one type of inorganic compound. The surface of the electrode active material layer has a concave/convex shape with a predetermined pattern and a certain pitch, and a height difference between a concave part and a convex part of the concave/convex shape is 10 μm or more. Here, at least a part of the coating component is disposed in the concave part of the concave/convex shape.

With such a configuration, it is possible to realize an increase in the surface area in which the electrode active material layer and the coating component come into contact with each other and disposition of the coating component on the electrode active material layer in the thickness direction. Thereby, the effect of having the coating component on the electrode active material layer is further exhibited.

In one preferable aspect of the electrode disclosed here, the electrode active material layer in the concave part is uniformly divided into three layers, an upper layer, an intermediate layer and a lower layer, in the thickness direction from the surface of the active material layer to the current collector, and when the electrode densities (g/cm³) of the upper layer, the intermediate layer, and the lower layer of the concave part are d₁, d₂, and d₃, respectively, they have a relationship of 0.8<(d₁/d₃)<1.1.

With such a configuration, regarding the electrode having a concave/convex shape, it is possible to provide an electrode in which there is no local increase (densification) in the electrode density in the concave part of the active material layer.

In one preferable aspect of the electrode disclosed here, the inorganic compound contains at least one selected from the group consisting of alumina, boehmite, silica, magnesia, zirconia and titania.

With such a configuration, it is possible to provide an electrode in which the mechanical strength of the electrode is improved and the concave/convex shape is maintained even if the electrode expands and contracts during charging/discharging.

In one preferable aspect of the electrode disclosed here, the coating component may contain at least one type of active material as the inorganic compound, and the active material may contain at least one metal element of silicon and tin as a constituent element.

With such a configuration, when the active material that can contribute to an increase in the capacity of the secondary battery is used as the coating component, it is possible to provide an electrode having an increased capacity.

### BRIEF DESCRIPTION OF THE DRAWINGS

FIG. 1 is a flowchart showing rough steps of a method of producing an electrode according to one embodiment;

FIG. 2 is a block diagram schematically showing a configuration of an electrode production device according to one embodiment;

FIG. 3A to 3D are illustrative diagrams schematically showing existence forms of a solid phase (solid component such as active material particles), a liquid phase (solvent), and a gas phase (void) in agglomerated particles constituting a moisture powder, with FIG. 3A showing a pendular state, FIG. 3B showing a funicular state, FIG. 3C showing a capillary state, and FIG. 3D showing a slurry state;

FIG. 4 is a diagram schematically showing a coating step according to one embodiment;

FIG. 5 is a diagram schematically illustrating an electrode according to one embodiment;

FIG. 6 is an illustrative diagram schematically showing a lithium ion secondary battery according to one embodiment; and

FIG. 7 is a cross-sectional SEM image of an electrode having an electrode active material layer formed using a gas-phase-controlled moisture powder and a coating component in a concave part of the active material layer.

### DETAILED DESCRIPTION

Hereinafter, preferable embodiments of a method of producing an electrode disclosed here and an electrode will be described using an electrode suitably used for a lithium ion secondary battery, which is a typical example of a secondary battery, as an example. Here, components other than those particularly mentioned in this specification that are necessary for implementation can be recognized by those skilled in the art as design matters based on the related art in the field. The method of producing an electrode disclosed here and the electrode can be implemented based on content disclosed in this specification and common general technical knowledge in the field.

Here, the sizes (a length, a width, a thickness, etc.) do not reflect actual sizes.

In addition, the notation “A to B (where A and B are arbitrary values)” indicating a range in this specification means A or more and B or less.

In this specification, “secondary battery” generally refers to a power storage device that can be repeatedly charged, and includes a so-called storage battery (that is, a chemical battery) such as a lithium ion secondary battery, a nickel metal hydride battery, and a nickel cadmium battery, as well as an electric double layer capacitor (that is, a physical battery). In addition, the term “lithium ion secondary battery” in this specification refers to a non-aqueous electrolyte solution secondary battery that uses lithium ions as a charge carrier and realizes charging/discharging by transferring charges associated with lithium ions between positive and negative electrodes. In this specification, an electrode is simply described when there is no need to particularly distinguish a positive electrode and a negative electrode.

Method of Producing Electrode

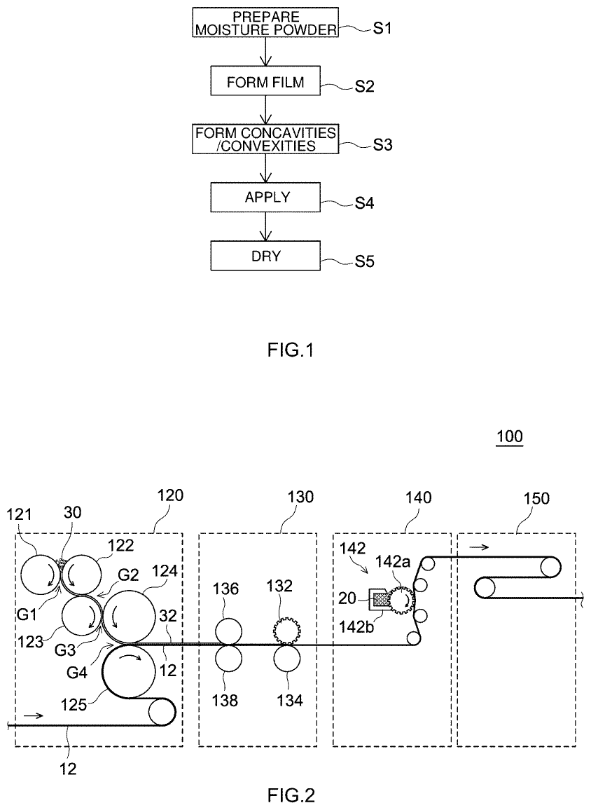

As shown in FIG. 1, roughly speaking, the method of producing an electrode disclosed here includes the following 5 steps: (1) a step in which a moisture powder (electrode material) is prepared (S1); (2) a step in which a coating film composed of the moisture powder is formed (S2); (3) a step in which concavities/convexities are formed on the coating film (S3); (4) a step in which a coating material is applied to the coating film after the concavities/convexities are formed (S4); and (5) a step in which the coating film and the coating material are dried (S5), and is characterized in that a coating material is applied to the coating film having a concave/convex shape before the drying step S5. Therefore, other steps are not particularly limited, and may have the same configuration as this type of conventional production method. Hereinafter, the steps will be described.

FIG. 2 is a block diagram schematically showing a schematic configuration of an electrode production device according to the method of producing an electrode disclosed here. An electrode production device 100 shown in FIG. 2 includes, typically, a film forming part 120 in which, while a sheet-shaped electrode the current collector 12 that has been transported from a supply chamber (not shown) in a longitudinal direction is transported, a coating film 32 made of an electrode material 30 is formed on the surface of the electrode current collector 12, a coating film processing part 130 in which a concave/convex shape is formed on the surface of the coating film 32, a coating part 140 in which a coating material 20 is applied to the coating film 32 having a concave/convex shape, and a drying part 150 in which the coating film 32 and the coating material 20 are appropriately dried to form an electrode active material layer 14 and a coating component 22 disposed in a concave part of the active material layer 14. These are disposed in order along a predetermined transport path.

### Preparing Step

The electrode material 30 can be prepared by mixing the above electrode active material, a solvent, a binder resin, and materials such as other additives using a conventionally known mixing device. Examples of such a mixing device include a planetary mixer, a ball miller, a roll miller, a kneader, and a homogenizer.

The electrode material 30 can have the form of a paste, a slurry, or a granulated component, and the granulated component, particularly, a moisture granulated component (moisture powder) containing a small amount of a solvent, is suitable for forming an electrode active material layer on the electrode current collector 12 in the electrode production device 100 disclosed here. In this specification, the moisture powder morphological classification is described in “Particle Size Enlargement” by Capes C. E. (published by Elsevier Scientific Publishing Company, 1980), four classifications that are currently well known are used in this specification, and the moisture powder disclosed here is clearly defined. Specifically, it is as follows. The existence forms (filled state) of a solid component (solid phase), a solvent (liquid phase) and voids (gas phase) in the agglomerated particles constituting a moisture powder can be classified into four states: “pendular state”, “funicular state”, “capillary state”, and “slurry state”.

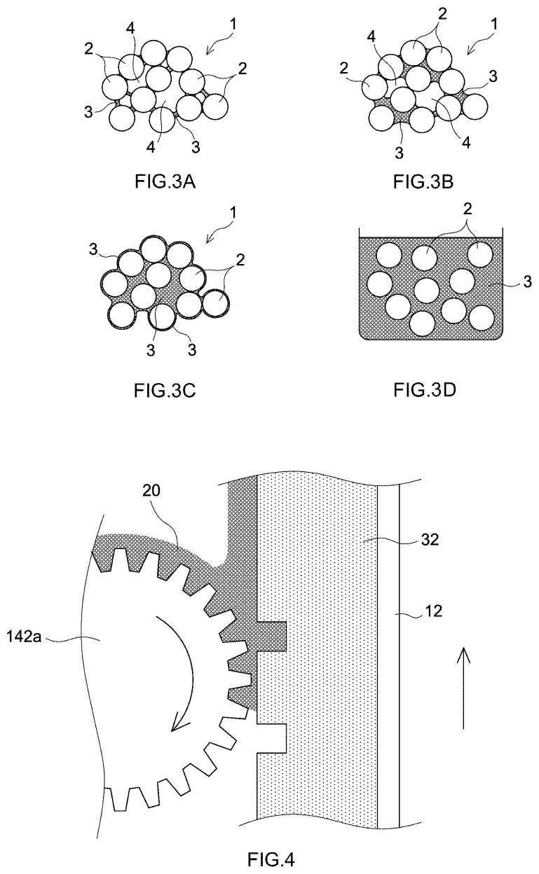

Here, as shown in FIG. 3A, “pendular state” refers to a state in which a solvent (liquid phase) 3 is discontinuously present to crosslink active material particles (solid phase) 2 in an agglomerated particle 1, and the active material particles (solid phase) 2 may be present in a (continuous) state in which they are connected to each other. As shown, the content of the solvent 3 is relatively low, and as a result, most voids (gas phase) 4 present in the agglomerated particle 1 are continuously present and form communication holes that lead to the outside. In addition, one characteristic of the pendular state is that a continuous solvent layer is not observed over the entire outer surface of the agglomerated particle 1 in electron microscope observation (SEM observation).

In addition, as shown in FIG. 3B, “funicular state” refers to a state in which the content of the solvent in the agglomerated particle 1 is relatively higher than that of a pendulum, and a state in which the solvents (liquid phase) 3 are continuously present around the active material particles (solid phase) 2 in the agglomerated particle 1. However, since the amount of the solvent is still small, as in the pendular state, the active material particles (solid phase) 2 are present in a (continuous) state in which they are connected to each other. On the other hand, among the voids (gas phase) 4 present in the agglomerated particle 1, the proportion of communication holes that lead to the outside decreases slightly, and the abundance proportion of the discontinuous isolated voids tends to increase, but the presence of communication holes is recognized.

The funicular state is a state between the pendular state and the capillary state, and if funicular states are classified into a funicular I state, which is closer to the pendular state (that is, a state in which the amount of solvent is relatively low), and a funicular II state, which is closer to the capillary state (that is, a state in which the amount of solvent is relatively high), a funicular I state encompasses a state in which a connected layer of solvent is not observed at the outer surface of the aggregated particle 1 in electron microscope observations (SEM observations).

As shown in FIG. 3C, in the “capillary state”, the content of the solvent in the agglomerated particle 1 increases, the amount of the solvent in the agglomerated particle 1 becomes close to a saturated state, a sufficient amount of the solvent 3 is continuously present around the active material particles 2, and as a result, the active material particles 2 are present in a discontinuous state. Almost all voids (gas phase) present in the agglomerated particle 1 (for example, a total void volume of 80 vol %) are present as isolated voids due to the increase in the amount of the solvent, and the abundance proportion of voids in the agglomerated particle also becomes small. As shown in FIG. 3D, “slurry state” refers to a state in which the active material particles 2 have already been suspended in the solvent 3, and a state that cannot be called agglomerated particles. There is almost no gas phase.

In the related art, moisture powder sheeting in which a film is formed using a moisture powder is known, but in the conventional moisture powder sheeting, the moisture powder is in a so-called “capillary state” shown in FIG. 3C in which a liquid phase is continuously formed throughout the powder.

On the other hand, the moisture powder disclosed here is a moisture powder in which at least 50% by number or more of the agglomerated particles 1 form the pendular state or the funicular state (in particular, the funicular I state) (1). Preferably, the moisture powder has one morphological characteristic in which, when the gas phase is controlled, no layer formed of the solvent is observed over the entire outer surface of the agglomerated particles in electron microscope observation (2). Hereinafter, the moisture powder disclosed here that satisfies the requirements (1) and (2) is referred to as a “gas-phase-controlled moisture powder”.

Here, in the gas-phase-controlled moisture powder disclosed here, it is preferable that at least 50% by number or more of the agglomerated particles satisfy the requirements (1) and (2).

The gas-phase-controlled moisture powder can be produced according to a conventional process of producing a moisture powder in a capillary state. That is, when the amount of the solvent and the formulation of solid components (the active material particles, the binder resin, etc.) are adjusted so that the proportion of the gas phase is higher than in the related art, and specifically, many continuous voids (communication holes) that lead to the outside are formed in the agglomerated particles, it is possible to produce a moisture powder as an electrode material (electrode mixture) included in the pendular state or the funicular state (in particular, the funicular I state).

In addition, in order to realize a liquid crosslink between active materials with a smallest amount of the solvent, it is desirable that the surface of the powder material used and the solvent used have an appropriate affinity.

Preferably, examples of appropriate gas-phase-controlled moisture powders disclosed here include a moisture powder in which a three-phase state recognized in electron microscope observation is a pendular state or funicular state (in particular, the funicular I state) and in which “the ratio of the loose bulk specific gravity X and the true specific gravity Y (Y/X)” is 1.2 or more, preferably 1.4 or more (and further preferably 1.6 or more) and is 2 or less, the ratio being calculated from the loose bulk specific gravity X (g/mL), which is measured by placing an obtained moisture powder in a container having a prescribed volume (mL) and then leveling the moisture powder without applying a force, and the raw material-based true specific gravity Y (g/mL), which is the specific gravity calculated from the composition of the moisture powder on the assumption that no gas phase is present.

The electrode material 30 forming the electrode active material layer contains at least a plurality of electrode active material particles, a binder resin, and a solvent.

As the electrode active material which is a main component of the solid component, a compound having a composition used as a negative electrode active material or a positive electrode active material of a conventional secondary battery (here, a lithium ion secondary battery) can be used. Examples of negative electrode active materials include carbon materials such as graphite, hard carbon, and soft carbon. In addition, examples of positive electrode active materials include lithium transition metal composite oxides such as LiNi_{1/3}Co_{1/3}Mn_{1/3}O₂, LiNiO₂, LiCoO₂, LiFeO₂, LiMn₂O₄, and LiNi_{0.5}Mn_{1.5}O₄and lithium transition metal phosphate compounds such as LiFePO₄. The average particle size of the electrode active material is not particularly limited, and is suitably about 0.1 μm to 50 μm, and preferably about 1 to 20 μm. Here, in this specification, “average particle size” refers to a particle size (D₅₀, also referred to as a median diameter) corresponding to a cumulative frequency of 50 vol % from the fine particle end having a small particle size in a volume-based particle size distribution based on a general laser diffraction/light scattering method.

As the solvent, for example, N-methyl-2-pyrrolidone (NMP) or an aqueous solvent (water or a mixed solvent mainly composed of water) can be preferably used.

Examples of binder resins include polyvinylidene fluoride (PVDF), carboxymethyl cellulose (CMC), styrene butadiene rubber (SBR), and polyacrylic acid (PAA). An appropriate binder resin is used depending on the solvent used.

The electrode material 30 may contain a substance other than the electrode active material and the binder resin as the solid components, for example, a conductive material and a thickener. Preferable examples of conductive materials include carbon black, for example, acetylene black (AB), and carbon materials such as carbon nanotubes. In addition, as the thickener, for example, carboxymethyl cellulose (CMC) and methyl cellulose (MC) can be preferably used. The electrode material 30 may include materials (for example, various additives) other than the above materials.

Here, in this specification, “solid component” refers to a material (solid material) excluding the solvent among the above materials, and “solid component proportion” refers to a proportion of the solid component in the electrode material in which materials are mixed.

Wet granulation can be performed using the above materials to produce a desired moisture powder. Specifically, for example, respective materials are mixed using a stirring granulation machine (a mixer such as a planetary mixer) to produce a moisture powder (that is, an aggregate of agglomerated particles). This type of stirring granulation machine includes a mixing container that is typically cylindrical, a rotary blade accommodated in the mixing container, and a motor connected to the rotary blade (also referred to as a blade) via a rotating shaft.

In the preparing step S1, among the above materials, first, materials (solid components) excluding the solvent are mixed in advance to perform a solvent-less dry dispersion treatment. Therefore, a state in which respective solid components are highly dispersed is formed. Then, preferably, a solvent and other liquid components (for example, a liquid binder) are added to the dispersed mixture and additionally mixed. Accordingly, a moisture powder in which respective solid components are suitably mixed can be produced.

Specifically, an electrode active material which is a solid component and various additives (a binder resin, a thickener, a conductive material, etc.) are put into the mixing container of the stirring granulation machine, the motor is driven to rotate the rotary blade, for example, at a rotational speed of 2,000 rpm to 5,000 rpm for about 1 to 60 seconds (for example, 2 to 30 seconds), and thus a mixture of respective solid components is produced. Then, an appropriate amount of the solvent is weighed out so that the solid component is 70% or more, and more preferably 80% or more (for example, 85% to 98%), and is put into the mixing container, and a stirring granulation treatment is performed. Although not particularly limited, the rotary blade is additionally rotated, for example, at a rotational speed of 100 rpm to 1,000 rpm for about 1 to 60 seconds (for example, 2 to 30 seconds). Accordingly, respective materials and the solvent in the mixing container can be mixed to produce a moisture granulated component (moisture powder). Here, additionally, when stirring is intermittently performed at a rotational speed of about 1,000 rpm to 3,000 rpm for a short time of about 1 to 5 seconds, it is possible to prevent aggregation of the moisture powders. The particle size of the obtained granulated component can be, for example, 50 μm or more (for example, 100 μm to 300 μm).

In the gas-phase-controlled moisture powder disclosed here, a solid phase, a liquid phase, and a gas phase form a pendular state or a funicular state (preferably, the funicular I state), and the solvent content is low to the extent that no solvent layer is observed on the outer surface of the agglomerated particles in electron microscope observation (for example, the solvent proportion may be about 2 to 15% or 3 to 8%), and conversely, the gas phase part is relatively large.

In order to obtain such an existence form, in the above preparing step S1, various treatments and operations that can increase the gas phase can be incorporated. For example, during stirring granulation or after granulation, the granulated component is exposed to a dry gas (air or inert gas) atmosphere heated to a temperature about 10 to 50 degrees higher than room temperature, and thus an excess solvent may be evaporated. In addition, in order to promote formation of agglomerated particles in the pendular state or funicular I state when the amount of the solvent is small, compressive granulation with a relatively strong compressive action may be used in order to adhere the active material particles and other solid components to each other. For example, a compressive granulation machine in which granulation is performed when a compressive force is applied between rollers while a powder raw material is supplied between a pair of rollers in a vertical direction may be used.

Film Forming Step

The production method disclosed herein is characterized in that the coating film 32 is formed while leaving a gas phase (void) of the electrode material 30. Formation of the coating film 32 composed of the electrode material 30 can be performed in, for example, the film forming part 120 schematically shown in FIG. 2. As shown, the film forming part 120 includes a plurality of continuous transfer rollers. In this example, it includes a first transfer roller 122 that faces a supply roller 121, a second transfer roller 123 that faces the first transfer roller, and a third transfer roller 124 that faces the second transfer roller and also faces a backup roller 125. With such a configuration, the sizes of gaps G1 to G4 between rollers can be made different, and the appropriate coating film 32 can be formed while maintaining communication holes for the moisture powder. This will be described below in detail.

In the film forming part 120, the outer peripheral surface of the supply roller 121 and the outer peripheral surface of the first transfer roller 122 face each other, and this pair of the supply roller 121 and the first transfer roller 122 rotate in directions opposite to each other as indicated by the arrows as shown in FIG. 2. In addition, the supply roller 121 and the first transfer roller 122 have a gap G1 with a predetermined width (thickness) according to a desired thickness of the coating film 32 formed on the electrode current collector 12, and it is possible to control the thickness of the coating film 32 composed of the electrode material 30 to be adhered to the surface of the first transfer roller 122 according to the size of the gap G1. In addition, by adjusting the size of the gap G1, it is possible to adjust a force with which the electrode material 30 that passes between the supply roller 121 and the first transfer roller 122 is compressed. Therefore, by making the gap size relatively large, it is possible to form a film when the gas phase of the electrode material 30 (specifically, each agglomerated particle) is maintained.

For the electrode material 30 compressed by the supply roller 121 and the first transfer roller 122, the second transfer roller 123 and the third transfer roller 124 form a film while adjusting the gas phase state of the electrode material 30. The second transfer roller 123 and the third transfer roller 124 rotate in directions opposite to each other as indicated by the arrows shown in FIG. 2. In addition, the second gap G2 is provided between the first transfer roller 122 and the second transfer roller 123, the third gap G3 is provided between the second transfer roller 123 and the third transfer roller 124, and when the gaps G2 and G3 are adjusted, the coating film 32 having a desired thickness and in a gas phase state can be produced.

The backup roller 125 has a function of transporting the electrode current collector 12 to the third transfer roller 124. The third transfer roller 124 and the backup roller 125 rotate in directions opposite to each other as indicated by the arrows shown in FIG. 2. In addition, the fourth gap G4 with a predetermined width (thickness) is provided between the third transfer roller 124 and the backup roller 125, and it is possible to control the thickness of the coating film 32 formed on the electrode current collector 12 depending on the size of the gap G4.

Regarding the electrode current collector 12, a metal electrode current collector used as an electrode current collector of this type of secondary battery can be used without particular limitation. When the electrode current collector 12 is a positive electrode current collector, the electrode current collector 12 is made of, for example, a metal material having favorable conductivity such as aluminum, nickel, titanium, or stainless steel. In particular, aluminum (for example, an aluminum foil) is preferable. When the electrode current collector 12 is a negative electrode current collector, the electrode current collector 12 is made of, for example, a metal material having favorable conductivity such as copper, an alloy mainly composed of copper, nickel, titanium, or stainless steel. In particular, copper (for example, a copper foil) is preferable. The thickness of the electrode current collector 12 is, for example, about 5 μm to 20 μm, and preferably 8 μm to 15 μm.

Since the supply roller 121, the first transfer roller 122, the second transfer roller 123, the third transfer roller 124 and the backup roller 125 are connected to independent driving devices (motors) (not shown), they can be rotated at different rotational speeds. Specifically, the rotational speed of the first transfer roller 122 is higher than the rotational speed of the supply roller 121, the rotational speed of the second transfer roller 123 is higher than the rotational speed of the first transfer roller 122, the rotational speed of the third transfer roller 124 is higher than the rotational speed of the second transfer roller 123, and the rotational speed of the backup roller 125 is higher than the rotational speed of the third transfer roller 124. In this manner, when the rotational speed between rotary rollers is gradually increased in the current collector transport direction (traveling direction), it is possible to perform roll film formation.

The sizes of the gaps are set so that the first gap G1 is relatively a maximum, and the second gap G2, the third gap G3, and the fourth gap G4 are gradually reduced in this order (G1>G2>G3>G4). Since the gaps G1 to G4 are set so that the gaps gradually decrease in the transport direction (traveling direction) of the electrode current collector 12, film formation can be performed while adjusting the gas phase (void) state of the coating film 32. Although not particularly limited, the sizes (widths) of the gaps G1 to G4 may be set to be gap sizes so that the average film thickness of the coating film 32 is 10 μm or more and 300 μm or less (for example, 20 μm or more and 150 μm or less).

A partition wall (not shown) may be provided at both ends of the supply roller 121 and the transfer roller 122 in the width direction. The partition wall can hold the electrode material 30 on the supply roller 121 and the transfer roller 122 and define the width of the coating film 32 formed on the electrode current collector 12 by a distance between two partition walls. The electrode material 30 is supplied between the two partition walls by a feeder (not shown) or the like.

The sizes of the supply roller 121, the first transfer roller 122, the second transfer roller 123, the third transfer roller 124 and the backup roller 125 are not particularly limited, and may be the same as those of the conventional film formation device, and for example, the diameters may be 50 mm to 500 mm. The diameters of the supply roller 121, the first to third transfer rollers 122, 123, and 124 and the backup roller 125 may be the same or different. In addition, the width of the coating film 32 formed may be the same as that of the conventional film formation device, and can be appropriately determined according to the width of the electrode current collector 12 on which the coating film 32 will be formed.

The materials of the outer peripheral surfaces of the supply roller 121, the first transfer roller 122, the second transfer roller 123, the third transfer roller 124 and the backup roller 125 may be the same as the material of the rotary roller in the conventional known film formation device, and examples thereof include SUS steel and SUJ steel. In order to prevent generation of metallic foreign substances, the materials of the outer peripheral surfaces of the supply roller 121 and the first to third transfer rollers 122, 123, and 124 that are in direct contact with the electrode material 30 are more preferably, for example, a ceramic such as zirconia, alumina, chromium nitride, aluminum nitride, titania, or chromium oxide.

Here, as an example, FIG. 2 shows arrangement of the supply roller 121, the first transfer roller 122, the second transfer roller 123, the third transfer roller 124 and the backup roller 125, but the arrangement of these rollers is not limited thereto.

Concave/Convex Forming Step

Formation of concavities/convexities on the coating film 32 can be performed, for example, using a concavity/convexity transfer roller 132 and a backup roller 134 as shown in FIG. 2. The method for producing an electrode disclosed herein is characterized in that a concave/convex forming step S3 is carried out on the coating film 32 formed while leaving voids (gas phases). The average porosity (gas phase rate) of the coating film 32 is preferably at least 1% or more, and may be, for example, 1% or more and 55% or less, typically 5% or more and 55% or less. If concavities/convexities are formed when the gas phase remains, since the spreadability is improved, a desired concave/convex shape can be imparted to the coating film 32 with a load smaller than in the related art. In addition, even if a load is applied to form concavities/convexities, a concave/convex shape can be formed on the surface part of the coating film 32 without locally increasing the density (densification).

Here, in this specification, the “average porosity (gas phase rate) of the coating film” can be calculated by, for example, observing the cross section of the coating film using a scanning electron microscope (SEM). The cross-section image is subjected to binarization processing so that the solid phase or liquid phase part turns white and the gas phase (void) part turns black using image analysis software “ImageJ” which is an open source and well-known as public domain image processing software. Thereby, “S2/(S1+S2)×100” can be calculated where an area of a part (white part) in which a solid phase or a liquid phase is present is called S1, and an area of a void part (black part) is called S2. This is defined as a porosity of the coating film before drying. A plurality of cross-sectional SEM images are acquired (for example, 5 or more images), and the average value of the porosities is defined as an “average porosity (gas phase rate) of the coating film” before drying. Here, the “average porosity (gas phase rate) of the coating film” does not include a concave part (that is, macro voids) formed in the process of forming concavities/convexities.

The concavity/convexity transfer roller 132 has a concave part and a convex part for forming a predetermined pattern with a certain pitch on the surface of the coating film 32. The backup roller 134 is a roller for feeding the transported the electrode current collector 12 in the transport direction while supporting it. The concavity/convexity transfer roller 132 and the backup roller 134 are disposed at opposite positions. When the coating film 32 on the electrode current collector 12 passes through the gap between the concavity/convexity transfer roller 132 and the backup roller 134, the concave/convex part of the concavity/convexity transfer roller 132 is transferred to the surface of the coating film 32, and thus a desired shape can be formed on the surface of the coating film 32. The linear pressure of the concavity/convexity transfer roller 132 is not particularly limited because it may vary depending on the depth of the concave part having a desired shape and the like, but can be set to about 15 N/cm to 75 N/cm, for example, about 25 N/cm to 65 N/cm.

Here, a method of processing concavities/convexities on the coating film 32 can be performed by a method other than transfer of concavities/convexities using the concavity/convexity transfer roller. For example, a concave/convex shape may be formed on the surface part of the coating film 32 by pressing using a flat plate rolling mill having a desired concave/convex shape. In this case, the pressing pressure can be set to, for example, 1 MPa to 100 MPa, for example, about 5 MPa to 80 MPa.

The inventors conducted extensive studies, and as a result, found that the pitch between the concave part and the convex part of the concavity/convexity transfer roller 132 can be set to 250 μm or more and 5 mm or less (for example, 1 mm or more and 3 mm or less). With such a configuration, the coating film 32 after drying (electrode active material layer) can be appropriately provided with the concave part and the convex part.

When the reference represented by Lcm×Bcm (L and B are integers of 3 or more) is set in the surface area of the coating film 32, the average surface area measured at different n points (n is an integer of 5 or more) is about L×B cm². In the method of producing an electrode disclosed here, the concave/convex forming step S3 is preferably carried out so that the average surface area is 1.05×L×Bcm² or more (preferably 1.1×L×Bcm² or more). Therefore, a surface area in which the coating film 32 and the coating material 20 come into contact with each other can increase, and the effect of applying the coating material 20 can be more suitably exhibited.

In addition, the coating film processing part 130 may further include a mechanism for adjusting the film thickness and the gas phase state of the coating film 32 using a pressing roller 136 and a backup roller 138. The pressing roller 136 is a roller for pressing and compressing the coating film 32 in the film thickness direction, and the backup roller 138 is a roller for feeding the transported electrode current collector 12 in the transport direction while supporting it. The pressing roller 136 and the backup roller 138 are disposed at opposite positions. For example, the coating film 32 formed (film-formed) on the transported electrode current collector 12 can be pressed and compressed to the extent that no isolated voids are generated. Thereby, the gas phase state of the coating film 32 can be adjusted so that concavities/convexities are more suitably formed. An appropriate pressing pressure of the pressing roller 136 and the backup roller 138 is not particularly limited because it may vary depending on the film thickness and density of a desired coating film (electrode active material layer), and can be set to, for example, 0.01 MPa to 100 MPa, for example, about 0.1 MPa to 70 MPa.

In the coating film 32, when the gas phase remains, even if a concave/convex shape is formed before the drying step S4, a desired pattern is formed, and the pattern can be maintained. In addition, more suitably, the coating film 32 formed using the gas-phase-controlled moisture powder as the electrode material 30 is preferable. As described above, since the gas-phase-controlled moisture powder is formed into a film while communication holes are maintained, it is possible to more suitably form a desired pattern and maintain the pattern.

Coating Step

In the coating step of the coating material 20 on the coating film 32, various intaglio printing machines such as a gravure coater, a slit coater, a comma coater, a die coater such as a cap coater (capillary coater), and various coating devices such as a lip coater can be used. Among these, a gravure printing method is preferably used for application because the coating material 20 can be applied at a relatively high speed. For example, in FIG. 2 and FIG. 4, a direct gravure roll coater is exemplified as a coating device 142. The coating material 20 may be transferred to the coating film 32 by direct gravure using a gravure roller 142a in which a fine pattern is engraved on the surface. The outer peripheral surface of the gravure roller 142a has a groove for holding the coating material 20. The groove may have a size of about 10 to 30 μm (for example, 20 μm).

In the example shown in FIG. 2, the electrode current collector 12 is transported so that the treated surface to which the coating material 20 is applied (that is, the surface on the surface of the coating film 32) is in contact with the gravure roller 142a. The left side of the gravure roller 142a is immersed in the coating material 20 stored in a storage tank 142b, and when the gravure roller 142a rotates, a predetermined amount of the coating material 20 that has entered an engraving groove provided in the gravure roller 142a is transported to the right side of the roller (that is, the side that comes in contact with the coating film 32). Thereby, the coating material 20 stored in the storage tank 142b is continuously transferred to the surface part of the coating film 32 having a concave/convex shape via the groove of the gravure roller 142a.

FIG. 4 is a diagram schematically showing a state in which the coating material 20 is applied to the coating film 32 by the gravure roller 142a. The coating film 32 on the electrode current collector 12 is transported in a direction indicated by the arrow in the drawing. At least a part of the coating material 20 applied by the gravure roller 142a is disposed in the concave part of the coating film 32. In the production method disclosed here, as shown, the coating material 20 is also applied to the convex part of the coating film 32, and a layer whose composition is different from the coating film 32 (that is, a second layer) may be formed on the entire surface of the coating film 32.

The coating material 20 is composed of at least a solid material and a solvent. The coating material 20 includes at least one type of inorganic compound as a solid material. Examples of inorganic compounds include non-conductive (insulating) inorganic compound particles (so-called inorganic filler) and active material particles (so-called alloy-based active material) containing metal elements that can occlude and release lithium as constituent elements. Two or more types of these inorganic compounds may be used in combination.

Examples of non-conductive (insulating) inorganic compound particles include oxide-based ceramics such as alumina, silica, titania, zirconia, magnesia, ceria, and zinc oxide, and particles of silicon carbide, calcium carbonate, boehmite, talc, kaolin clay, montmorillonite, mica, zeolite, calcium silicate, magnesium silicate, aluminum silicate, and silica sand. Among these, it preferably contains at least one selected from the group consisting of alumina, boehmite, silica, magnesia, zirconia and titania. The average particle size of the inorganic compound is not particularly limited, and may be, for example, 15 μm or less (for example, 0.1 μm or more and 10 μm or less). When at least a part of the coating material 20 containing such inorganic compound particles is disposed in the concave part of the coating film 32, it is possible to improve the mechanical strength and liquid retention property of the concave part of the electrode active material layer.

In addition, the active material particles may contain at least one metal element that can occlude and release lithium as a constituent element. Preferable examples include a negative electrode active material (alloy-based active material) containing at least one metal element of silicon (Si) and tin (Sn) as a constituent element. Examples of Si (silicon)-based negative electrode active materials include elemental Si metals, oxides (for example, SiOx) containing Si as a constituent element, and alloys containing Si as a constituent element. Examples of Sn-based negative electrode active materials include elemental Sn metals, oxides (for example, SnOx) containing Sn as a constituent element, and alloys containing Sn as a constituent element. Examples of constituent elements other than Si and Sn in the alloys include metals such as Ti, Cr, Mn, Fe, Co, Ni, Cu, Zn, Nb, Mo, In, and Al, and particles of metal materials of alloys mainly composed of these metals. The average particle size of the active material particles is not particularly limited, and may be, for example, 0.5 μm or more and 50 μm or less (for example, 1 μm or more and 20 μm or less). When at least a part of the coating material 20 containing such active material particles is disposed in the concave part of the coating film 32, it is possible to realize an electrode active material layer in which the battery capacity is improved while alleviating expansion and contraction of the volume due to charging/discharging.

Here, in this specification, the “metal” may also include semimetals such as Si. In addition, the “alloy” refers to a mixture of two or more types of metals at a microscopic level, and the structure of the alloy may include, for example, a solid solution, an intermetallic compound and a substance in which they coexist.

The proportion of the inorganic compound in the solid material can be 60 mass % or more (typically 80 mass % or more, for example, 90 mass % or more, preferably 95 mass % or more), and 99.8 mass % or less (typically 99.5 mass % or less, for example, 99 mass % or less). Within such a range, characteristics of the coating material 20 can be sufficiently exhibited when applied to the surface of the coating film 32.

Here, in addition to the inorganic compound, examples of solid materials include a binder (polymer component) for binding the inorganic compound. As such a binder, for example, a binder that can be blended into the above electrode material can be appropriately selected and used.

As the solvent, either an aqueous solvent or a non-aqueous solvent can be used. As the aqueous solvent, water or a mixed solvent mainly composed of water is preferably used. As the solvent component other than water constituting such a mixed solvent, one or two or more organic solvents (lower alcohol, lower ketone, etc.) that can be uniformly mixed with water can be appropriately selected and used. For example, it is preferable to use an aqueous solvent in which 80 mass % or more (more preferably 90 mass % or more, and still more preferably 95 mass % or more) of the aqueous solvent is water. Particularly preferable examples include an aqueous solvent substantially composed of water. In addition, preferable examples of non-aqueous solvents include N-methyl-2-pyrrolidone (NMP).

The above solid material and solvent are mixed using the conventionally known mixing device used in the above preparing step Si so that the solid component proportion is about 40% to 90%, and the coating material 20 is adjusted. That is, the coating material 20 may be in any of four states of the pendular state, the funicular state, the capillary state and the slurry state described above. When the coating material 20 is in a pendular state or a funicular state (in particular, the funicular I state), two or more layers can be formed.

Use of the gas-phase-controlled moisture powder in the method of producing an electrode disclosed here is not particularly limited, and it has the following advantages.

When a coating material is applied to the coating film before the drying step is performed with respect to the coating film composed of a conventional slurry-like electrode material, the coating film and the coating material are mixed. On the other hand, when a coating material is applied to the coating film after the drying step is performed (that is, the electrode active material layer), the coating material permeates into voids formed in the coating film when the solvent evaporates (volatilizes). As a result, it is difficult to control the electrode in the thickness direction (Z direction) both before and after the drying step is performed. In addition, also in the coating film composed of a conventional solvent-rich moisture powder (that is, the capillary state), since a solvent layer is present on the outer surface of the agglomerated particles (that is, the surface of the coating film), when the coating material is applied, the coating film and the coating material are mixed sometimes.

On the other hand, as described above, in the gas-phase-controlled moisture powder in a pendular state or a funicular state (in particular, the funicular I state), since a continuous solvent layer is not observed over the entire outer surface of the agglomerated particles (that is, the surface of the coating film), when the coating film is formed using such a gas-phase-controlled moisture powder, it is possible to prevent the coating film and the coating material from being mixed together. Here, in addition to this, if a load is applied when concavities/convexities are formed, the gas phase rate (porosity) of the coating film is slightly reduced, and the active material particles (solid phase) can be more closely connected to each other. This can also prevent the coating material from penetrating into the coating film.

Drying Step

As shown in FIG. 2, a drying chamber including a heating device (heater) (not shown) as the drying part 150 is disposed downstream from the coating part 140 of the electrode production device 100 according to the present embodiment in the transport direction. In the drying part 150, the coating film 32 and the coating material 20 formed on the electrode current collector 12 are dried, and an electrode 10 including the electrode active material layer 14 composed of the coating film 32 and the coating component 22 composed of the coating material 20 disposed in the concave part in the concave/convex shape on the active material layer 14 is formed. The drying method is not particularly limited, and examples thereof include hot air drying and infrared drying. Here, since the drying step S5 may be the same as the drying step in this type of conventional electrode production device, and does not particularly characterize the present disclosure, more detailed description thereof will be omitted.

After the drying step S5, as necessary, when a pressing operation is performed at about 50 to 200 MPa, a long sheet-shaped electrode for a lithium ion secondary battery is produced. A sheet-shaped electrode produced in this manner is used for constructing a lithium ion secondary battery as a general this type of sheet-shaped positive electrode or negative electrode.

As shown in FIG. 5, the electrode 10 typically includes the electrode current collector 12, the electrode active material layer 14 formed on the current collector 12, and the coating component 22 containing at least one type of inorganic compound. The electrode 10 disclosed here has a concave/convex shape on the surface of the electrode active material layer 14 with a predetermined pattern and a certain pitch, and at least a part of the coating component 22 is disposed in the concave part of the active material layer 14.

The average film thickness of the electrode active material layer 14 is not particularly limited, and may be, for example, 10 μm or more and 300 μm or less (for example, 20 μm or more and 250 μm or less). In order to increase the capacity of the battery, the average film thickness is preferably thicker that in the related art, and may be, for example, about 150 μm or more and 300 μm or less (for example, 200 μm or more and 250 μm or less).

Here, the upper layer, the intermediate layer and the lower layer in this specification will be described with reference to FIG. 5. In FIG. 5, reference sign X indicates a longitudinal direction of the electrode and a reference sign Z indicates a thickness direction of the electrode. The concave part of the electrode active material layer 14 is uniformly divided into three layers, an upper layer, an intermediate layer and a lower layer. The lower layer, the intermediate layer, and the upper layer are positioned in this order in the thickness direction (Z direction) from the interface between the electrode active material layer 14 and the electrode current collector 12. For example, the lower layer is a position about 33% into the thickness of the electrode active material layer 14 from the interface between the electrode active material layer 14 and the electrode current collector 12 in the thickness direction (Z direction). Similarly, the intermediate layer and the upper layer are positions at which the thickness of the electrode active material layer 14 is divided into three equal parts. In addition, the electrode densities (g/cm³) of the upper layer, the intermediate layer and the lower layer in the concave part are d₁, d₂, and d₃, respectively.

Here, in this specification, the electrode density (g/cm³) of the upper layer, the intermediate layer and the lower layer can be obtained, for example, by multiplying the true density of the electrode by the filling rate in a corresponding range (that is, any of the upper layer, the intermediate layer and the lower layer). The true density of the electrode is, for example, a value calculated based on the density and the proportional content of constituent components. The filling rate in the corresponding range can be calculated by the same method as in the above method, for example, by performing binarization processing in cross section observation of the electrode active material layer using a scanning electron microscope (SEM). Specifically, the cross-section image is subjected to binarization processing so that the solid phase part present in the corresponding range turns white and the gas phase (void) part turns black using image analysis software “ImageJ” which is an open source and well-known as public domain image processing software. Thereby, “S1/(S1+S2)×100” can be calculated when the area of the part (white part) in which the solid phase is present called S1, and the area of the void part (black part) is called S2.

In the electrode 10 disclosed here (the electrode active material layer 14), a concave/convex shape is formed on the surface with a predetermined pattern and a certain pitch. In this specification, the “pattern” refers to a specific shape (design). The “pitch” refers to the smallest unit in which the concave part and the convex part are repeated. The pitch is not particularly limited, and for example, it is preferably 250 μm or more and 5 mm or less, more preferably 750 μm or more and 4 mm or less, and may be 1 mm or more and 3 mm or less. In addition, the concave part depth of the concave/convex shape (that is, the height difference of the concave/convex shape) is at least 10 μm or more, and about 10 to 100 μm (for example, 20 to 80 μm).

The electrode 10 disclosed here has a concave/convex shape on the surface of the electrode active material layer 14, and at least a part of the coating component 22 is disposed in the concave part of the concave/convex shape. At least a part of the coating component 22 may be disposed in the concave part, and as shown in the drawing, the coating component 22 is also disposed in the convex part, a layer whose composition is different from the electrode active material layer 14 (that is, a second layer) may be formed on the entire surface part of the active material layer 14.

The coating component 22 includes at least one type of inorganic compound. Examples of inorganic compounds include non-conductive (insulating) inorganic compound particles (so-called inorganic filler) and active material particles (so-called alloy-based active material) containing metal elements that can occlude and release Li as constituent elements. Regarding the non-conductive (insulating) inorganic compound particles (so-called inorganic filler), particles containing at least one selected from the group consisting of alumina, magnesia, zirconia, silica, boehmite, and titania are preferable. In addition, regarding the active material particles containing metal elements that can occlude and release Li as constituent elements, a negative electrode active material (alloy-based active material) containing at least one metal element of silicon (Si) and tin (Sn) as a constituent element is preferable. Two or more types of these inorganic compounds may be used in combination.

In the electrode 10 disclosed here, the electrode densities of the upper layer and the lower layer of the concave part have a relationship of 0.8<(d₁/d₃)<1.1. More preferably, the electrode densities of the upper layer and the lower layer of the concave part have a relationship of 0.9<(d₁/d₃)<1.08, and more preferably have a relationship of 0.95<(d₁/d₃)<1.08. When there is no difference in the electrode density between the upper layer and the lower layer of the concave part, the value of (d₁/d₃) is 1. That is, in the electrode 10 disclosed here, even though the concave/convex shape is formed, the difference in the electrode density between the upper layer and the lower layer of the concave part is small (that is, the (d₁/d₃) is close to 1). The electrode 10 can be realized using the above gas-phase-controlled moisture powder. Although not particularly limited, when concavities/convexities are formed in the coating film state having an appropriate solvent (liquid phase) and a gas phase, it is possible to move the active material (solid phase) to the part in which the gas phase is slightly reduced and minimize densification (local increase in density).

At least a part of the coating component 22 is disposed in the concave part of the electrode active material layer 14. In other words, the coating component 22 is held in the concave part of the electrode active material layer 14. If the coating component 22 containing the same inorganic compound is provided, it may have a more effective action than application to a conventional electrode having a flat surface (that is, an electrode in which a concave/convex shape is not intentionally formed; the same applies hereinafter).

Hereinafter, although not particularly limited, a case in which the coating component 22 containing boehmite is held in the concave part will be exemplified. When the coating component 22 containing boehmite is held in the concave part of the electrode active material layer 14, boehmite can function as a framework maintenance agent, and improve the mechanical strength of the concave part. Specifically, even if the electrode 10 repeatedly expands and contracts due to charging/discharging, the concave part shape of the electrode 10 can be maintained according to the action of boehmite. When the electrode 10 is used in a secondary battery, the concave part is maintained, and thus the concave part can more suitably retain an electrolyte (typically, a non-aqueous electrolyte solution). In addition to this, the concave part of the electrode 10 disclosed here is not densified, and functions as a Li ion insertion/desorption path. Therefore, even when compared with the conventional electrode, the effect of having an electrolyte retained in the concave part is strong.

Here, while boehmite has been exemplified, regarding such an effect, even if the coating component 22 containing non-conductive inorganic compound particles (so-called inorganic filler) such as alumina, silica, magnesia, zirconia and titania is held in the concave part, the same effect can be obtained.

In addition, hereinafter, although not particularly limited, a case in which active material particles (alloy-based active material) containing metal elements such as Si as constituent elements is held in the concave part will be described. The alloy-based active material such as Si has a high theoretical capacity and is useful as a negative electrode active material which contributes to increasing the capacity of the secondary battery, but the change in volume due to charging/discharging is large and tends to cause cracks. By selectively disposing such an active material as the coating component 22 in the concave part of the electrode active material layer 14 composed of the active material (for example, graphite) having a relatively small change in the volume due to charging/discharging, it is possible to obtain an electrode (in particular, a negative electrode) having an increased capacity while alleviating the above cracks.

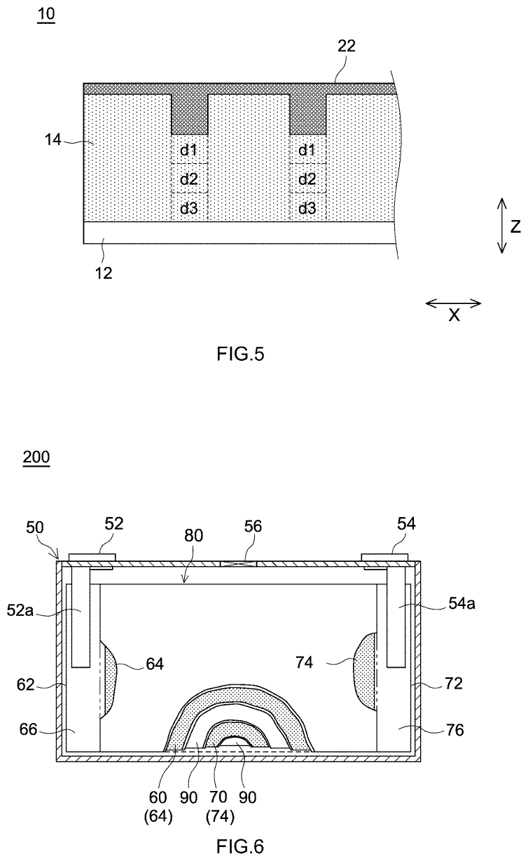

FIG. 6 shows an example of a lithium ion secondary battery 200 that can be constructed using the electrode 10 disclosed here.

The lithium ion secondary battery 200 shown in FIG. 6 is constructed by accommodating a flat wound electrode body 80 and a non-aqueous electrolyte solution (not shown) in a sealable box-shaped battery case 50. In the battery case 50, a positive electrode terminal 52 and a negative electrode terminal 54 for external connection, and a thin-walled safety valve 56 that is set, when an internal pressure of the battery case 50 increases to a predetermined level or more, to release the internal pressure are provided. In addition, a liquid injection port (not shown) for injecting a non-aqueous electrolyte solution is provided in the battery case 50. The positive electrode terminal 52 and a positive electrode current collector plate 52a are electrically connected. The negative electrode terminal 54 and a negative electrode current collector plate 54a are electrically connected. The material of the battery case 50 is preferably a metal material having a high strength, lightweightness, and favorable thermal conductivity, and examples of such metal materials include aluminum and steel.

The wound electrode body 80 typically has a form in which a long sheet-shaped positive electrode (hereinafter referred to as a positive electrode sheet 60) and a long sheet-shaped negative electrode (hereinafter referred to as a negative electrode sheet 70) overlap with a long sheet-shaped separator 90 therebetween, and are wound in the longitudinal direction. The positive electrode sheet 60 has a configuration in which a positive electrode active material layer 64 is formed on one surface or both surfaces of a positive electrode current collector 62 in the longitudinal direction. The negative electrode sheet 70 has a configuration in which a negative electrode active material layer 74 is formed on one surface or both surfaces of a negative electrode current collector 72 in the longitudinal direction. On one edge of the positive electrode current collector 62 in the width direction, a part in which the positive electrode active material layer 64 is not formed along the edge, and the positive electrode current collector 62 is exposed (that is, a positive electrode current collector exposed part 66) is provided. On the other edge of the negative electrode current collector 72 in the width direction, a part in which the negative electrode active material layer 74 is not formed along the edge, and the negative electrode current collector 72 is exposed (that is, a negative electrode current collector exposed part 76) is provided. The positive electrode current collector plate 52a and the negative electrode current collector plate 54a are bonded to the positive electrode current collector exposed part 66 and the negative electrode current collector exposed part 76.

For the positive electrode (the positive electrode sheet 60) and the negative electrode (the negative electrode sheet 70), the positive electrode and the negative electrode obtained by the above production method are used. Here, in this configuration example, in the positive electrode and the negative electrode, the electrode active material layer 14 (the positive electrode active material layer 64 and the negative electrode active material layer 74) is formed on both surfaces of the current collector 12 (the positive electrode current collector 62 and the negative electrode current collector 72).

Regarding the separator 90, for example, a porous sheet (film) made of a resin such as polyethylene (PE), polypropylene (PP), polyester, cellulose, and polyamide may be exemplified. Such a porous sheet may have a single-layer structure, or a laminate structure of two or more layers (for example, a three-layer structure in which a PP layer is laminated on both surfaces of a PE layer). In the separator 90, a heat resistant layer (HRL) may be provided.

Regarding the non-aqueous electrolyte, those used in the lithium ion secondary batteries in the related art can be used, and typically an organic solvent (non-aqueous solvent) containing a supporting salt can be used. Regarding the non-aqueous solvent, organic solvents such as carbonates, esters, ethers, nitriles, sulfones, and lactones can be used without particular limitation. Specifically, for example, non-aqueous solvents such as ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC), and trifluorodimethyl carbonate (TFDMC) can be preferably used. These non-aqueous solvents may be used alone or two or more thereof may be appropriately used in combination. Regarding the supporting salt, for example, a lithium salt such as LiPF₆, LiBF₄, and LiClO₄ can be suitably used. The concentration of the supporting salt is not particularly limited, and is preferably about 0.7 mol/L or more and 1.3 mol/L or less.

Here, as long as the effects of the present disclosure are not significantly impaired, the non-aqueous electrolyte solution may contain components other than the above non-aqueous solvent and supporting salt, for example, various additives such as a gas generating agent, a film forming agent, a dispersant, and a thickener.

The lithium ion secondary battery 200 configured as described above can be used for various applications. Examples of appropriate applications include drive power supplies mounted in vehicles such as battery electric vehicles (BEV), hybrid electric vehicles (HEV), and plug-in hybrid electric vehicles (PHEV). The lithium ion secondary battery 200 can be used in the form of an assembled battery in which a plurality of batteries are connected in series and/or parallel.

While examples in which the gas-phase-controlled moisture powder in a pendular state or a funicular state disclosed here is used as an electrode material will be described below, the technology disclosed here is not intended to be limited to what is shown in the examples.

### EXAMPLE 1

A gas-phase-controlled moisture powder that can be suitably used as a negative electrode material was produced, and a negative electrode active material layer was then formed on a copper foil using the produced moisture powder (negative electrode material).

In this test example, a graphite powder having an average particle size (D₅₀) of 10 μm based on a laser diffraction/scattering method was used as a negative electrode active material, styrene butadiene rubber (SBR) was used as a binder resin, carboxymethyl cellulose (CMC) was used as a thickener, and water was used as the solvent.

First, solid components including 98 parts by mass of the negative electrode active material, 1 part by mass of SBR and 1 part by mass of CMC were put into a stirring granulation machine (a planetary mixer or a high speed mixer), and mixed and stirred.

Specifically, in the stirring granulation machine having a mixing blade, the rotational speed of the mixing blade was set to 4,500 rpm, a stirring and dispersion treatment was performed for 15 seconds, and thereby a powder material mixture composed of the solid components was obtained. Water as the solvent was added to the obtained mixture so that the solid component proportion was 90 wt %, stirring granulation compositing was performed at a rotational speed of 300 rpm for 30 seconds, stirring was then performed at a rotational speed of 4,500 rpm for 2 seconds and refining was performed. Thereby, a moisture powder example (negative electrode material) according to this test was produced.

Then, the obtained gas-phase-controlled moisture powder (negative electrode material) was supplied to the film forming part of the electrode production device, and a coating film was transferred to the surface of a negative electrode current collector made of a copper foil prepared separately.

Such a coating film was transported to a coating film processing part and a concave/convex shape was imparted by a concavity/convexity transfer roller (linear pressure of about 40 N/cm). In this case, the concave/convex shape was formed so that the height difference between the concave part and the convex part of the concave/convex shape was 25 μm. The coating film having such a concave/convex shape was transported to the coating part, and a coating material containing an inorganic compound using a direct gravure roll coater. Thereby, a coating film in which at least a part of the coating material was disposed in the concave part was obtained.

Here, regarding the coating material, a material prepared by mixing a solid component including 99 parts by mass of boehmite and 1 part by mass of PVDF in a stirring granulation machine and adding NMP as a solvent was used.

The coating film coated with such a coating material was heated and dried in the drying part and pressed by a roll rolling mill. Thereby, an electrode having an electrode active material layer and in which at least a part of the coating component was disposed in the concave part of the active material layer was obtained.

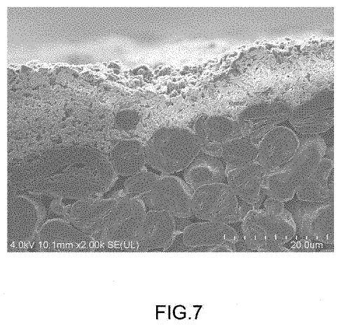

The state of the concave part of the electrode active material layer (that is, the coating film after drying) of Example 1 obtained above was observed under an SEM. The results are shown in FIG. 7.

In addition, the electrode densities (g/cm³) of the upper layer and the lower layer of the concave part of the electrode active material layer of Example 1 were measured. Here, the electrode density of the upper layer and the lower layer was determined by multiplying the true density of the electrode active material layer by a filling rate in the corresponding range. The true density of the electrode was calculated based on the density and proportional content of constituent components. In addition, the filling rate in the corresponding range was calculated by performing binarization processing using image analysis software “ImageJ” in cross section observation of the electrode active material layer using a scanning electron microscope (SEM).

As a result, the electrode density d₁ of the upper layer of the concave part was 1.2 g/cm³, and the electrode density d₃ of the lower layer of the concave part was 1.2 g/cm³.

### COMPARATIVE EXAMPLE 1

As a comparison target, an electrode in which a coating component containing an inorganic compound was disposed on an electrode active material layer having no concave/convex shape was prepared. Specifically, electrode materials were mixed in the same manner as in Example 1, and a coating film was transferred to the surface of a negative electrode current collector made of a copper foil prepared separately. Such a coating film was transported to the coating part, and a coating material containing an inorganic compound was applied using a direct gravure roll coater. Thereby, a coating film in which the coating material was applied to the surface of the coating film was obtained.

The coating film coated with such a coating material was heated and dried in the drying part and pressed by a roll rolling mill. Thereby, an electrode including an electrode active material layer and a coating component on the surface of the active material layer was obtained.

Production of Lithium Ion Secondary Battery for Evaluation

A lithium ion secondary battery for evaluation was produced using the produced electrodes of Example 1 and Comparative Example 1.

For the positive electrodes of Example 1 and Comparative Example 1, a positive electrode made of an electrode material in a slurry state was prepared.

In addition, two porous polyolefin sheets having a three-layer structure of PP/PE/PP were prepared as separator sheets.

The produced electrodes of Example 1 and Comparative Example 1, the positive electrode, and the two prepared separator sheets overlapped and were wound to produce a wound electrode body. Electrode terminals were adhered by welding to the positive electrode sheet and the negative electrode sheet of the produced wound electrode body, and these were accommodated in a battery case having an injection port.

The non-aqueous electrolyte solution was injected from such an injection port, and the injection port was air-tightly sealed with a sealing lid. Here, regarding the non-aqueous electrolyte solution, a solution in which LiPF₆ as a supporting salt at a concentration of 1.0 mol/L was dissolved in a mixed solvent containing ethylene carbonate (EC), dimethyl carbonate (DMC), and ethyl methyl carbonate (EMC) at a volume ratio of 1:1:1 was used. As described above, a lithium ion secondary battery for evaluation was obtained.

Activation Treatment

Each lithium ion secondary battery for evaluation was activated (initially charged) under an environment of 25° C. The activation treatment was a constant current-constant voltage method, and constant current charging was performed to 4.2 V at a current value of 1/3C, constant voltage charging was then performed until the current value reached 1/50C, and thus a fully charged state was obtained. Then, constant current discharging was performed until the voltage became 3.0 V at a current value of 1/3C.

Measurement of Electrode Expansion Coefficient

The film thickness of the negative electrode of each example before the lithium ion secondary battery for evaluation was prepared was measured using a contact type micrometer. The film thickness was measured at three points, and the average value of the film thickness was used as an average film thickness before charging/discharging.

Each lithium ion secondary battery for evaluation after the activation treatment was left under an environment of 25° C., and a charging/discharging cycle in which constant current charging was performed to 4.3 V at 30C and constant current discharging was performed to 3.1 V at 30C, which was one cycle, was repeated for 10 cycles. The cycle was stopped in the fully charged state at the 10th cycle, the lithium ion secondary battery for evaluation was disassembled, and the film thickness of the negative electrode was measured in the same manner as in the above method. The average value of the film thickness was used as an average film thickness after charging/discharging.

The electrode expansion coefficient was calculated by the formula: (the average film thickness after charging/discharging-the average film thickness before charging/discharging)/average film thickness before charging/discharging×100. It can be evaluated that, when the electrode expansion coefficient is smaller, the effect of having the coating component is stronger.

As shown in FIG. 7, in the electrode of Example 1, the electrode active material layer and the coating component were present without being mixed, and at least a part of the coating component was disposed in the concave part of the electrode active material layer. In addition, it was also observed that concavities/convexities were formed without densifying the electrode active material layer.

The electrode expansion coefficient was 3% in Example 1 and 5% in Comparative Example 1. That is, it can be understood that, when a coating component was applied to an electrode active material layer having a concave/convex shape, the effect of having the coating component is further exhibited.

While specific examples of the present disclosure have been described above in detail, these are only examples, and do not limit the scope of the claims. The technologies described in the claims include various modifications and alternations of the specific examples exemplified above.

What is claimed is:

1. A method of producing an electrode for a secondary battery having any electrode current collector of positive and negative electrodes and an electrode active material layer, the method including the following steps:
a step in which a moisture powder is prepared, the moisture powder is formed of agglomerated particles containing at least an electrode active material, a binder resin, and a solvent, and at least 50% by number or more of the agglomerated particles have the following properties:
(1) a solid phase, a liquid phase, and a gas phase form a pendular state or a funicular state; and
(2) a layer of the solvent is not observed on the outer surface of the agglomerated particles in electron microscope observation;
a step in which a coating film composed of the moisture powder is formed using the moisture powder on the electrode current collector while leaving a gas phase of the coating film;
a step in which a concave/convex shape is formed on a surface part of the coating film with a predetermined pattern and a certain pitch;
a step in which a coating material containing at least one type of inorganic compound is applied to the coating film on which the concave/convex shape is formed; and
a step in which the coating film formed on the electrode current collector and the coating material are dried, and the electrode having an electrode active material layer made of the coating film and a coating component made of the coating material disposed in a concave part of the concave/convex shape on the active material layer is formed.

2. The method of producing an electrode for a secondary battery according to claim 1, wherein the concave/convex forming step is carried out such a way as to form a concave/convex surface in which, when the surface area of a reference area of the coating film indicated by L cm×B cm (L and B are integers of 3 or higher) is measured at n (n is an integer of 5 or higher) different points, the average surface area is 1.05×L×B cm² or more.

3. The method of producing an electrode for a secondary battery according to claim 1, wherein the inorganic compound contains at least one selected from the group consisting of alumina, boehmite, silica, magnesia, zirconia and titania.

4. The method of producing an electrode for a secondary battery according to claim 1, wherein the coating material contains at least one type of active material as the inorganic compound, and the active material contains at least one metal element of silicon and tin as a constituent element.

5. An electrode for a secondary battery which is any electrode of positive and negative electrodes of a secondary battery, comprising
an electrode current collector, an electrode active material layer formed on the electrode current collector, and a coating component containing at least one type of inorganic compound,
wherein the surface of the electrode active material layer has a concave/convex shape with a predetermined pattern and a certain pitch, and
wherein a height difference between a concave part and a convex part of the concave/convex shape is 10 μm or more, and
wherein at least a part of the coating component is disposed in the concave part of the concave/convex shape.

6. The electrode for a secondary battery according to claim 5,
wherein the electrode active material layer in the concave part is uniformly divided into three layers, an upper layer, an intermediate layer and a lower layer, in the thickness direction from the surface of the active material layer to the current collector, and when the electrode densities (g/cm³) of the upper layer, the intermediate layer, and the lower layer of the concave part are d₁, d₂, and d₃, respectively, they have a relationship of 0.8<(d₁/d₃)<1.1.

7. The electrode for a secondary battery according to claim 5, wherein the inorganic compound contains at least one selected from the group consisting of alumina, boehmite, silica, magnesia, zirconia and titania.

8. The electrode for a secondary battery according to claim 5, wherein the coating component contains at least one type of active material as the inorganic compound, and the active material contains at least one metal element of silicon and tin as a constituent element.
